(19) United States
(12) Patent Application Publication
(10) Pub. No.: US 2009/0009479 A1
(43) Pub. Date: Jan. 8, 2009

(54) SYSTEM AND METHOD FOR TIME DIVISION INPUT ON A DYNAMIC GRAPHIC INPUT DEVICE

(76) Inventor: Richard Kevin SAWYER, Durham, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/773,551

(22) Filed: Jul. 5, 2007

(51) Int. Cl. G06F 3/02

(52) U.S. Cl. 345/169

(57) ABSTRACT

A mobile device comprises a key switch and a graphic display region associated with the key switch. A display control application drives, on a predetermined alternation time schedule between a first time period and a second time period: i) display of a first icon on the graphic display region during the first time period when activation of the key switch activates a first mobile device function; and ii) display a second icon, different than the first icon, on the graphic display region during the second time period when activation of the key switch activates a second mobile device function.

### TECHNICAL FIELD OF THE INVENTION

The present invention relates to a mobile device user interface and, in particular, for dynamically altering the appearance and function of user interface key switches based on the operational state of the mobile device.

### DESCRIPTION OF THE RELATED ART

Contemporary portable devices, including mobile telephones, portable data assistants (PDAs), and other mobile electronic devices typically included many embedded applications in addition to traditional communication applications such as mobile telephony.

Examples of such applications include address books applications, MP3 player applications and related systems, image capture (e.g. camera) applications and related systems, games, calculators, etc.

The user interface of a typical portable device comprises a graphic display and a plurality of key switches. Further, the graphic display may include an overlaying touch panel. The key switches may include permutations of a traditional telephony switches (e.g. 0-9, *, and #), a full miniature alpha numeric key pad, and one or more additional key switches such as a 5-way multi function key switch.

The typical 5-way multi-function key switch is positioned near the display screen and is used to navigate a cursor up/down and left/right. Depressing the center switch selects the option indicated by the then current position of the highlight bar.

The continued improvements in performance and reduction in size, of computerized system enable more sophisticated systems and applications to be embedded in mobile devices. However, the restricted size of the display and key switches comprising a mobile device interface remains a limitation to any system or application embedded in a mobile device.

What is needed is an improved user interface system and method for facilitating use of mobile device key switches with multiple applications and for multiple functions. Further, what is needed is a system and method for displaying the active function associated with each of a plurality of key switches, such as the five key switches of a five-way multi-function key switch.

### SUMMARY

A first aspect of the present invention comprises a mobile device with at least one key switch and a graphic display region associated with the key switch. A display control application drives, on a predetermined alternation time schedule between a first time period and a second time period: i) display of a first icon on the graphic display region during the first time period when activation of the key switch activates a first mobile device function; and ii) display a second icon, different than the first icon, on the graphic display region during the second time period when activation of the key switch activates a second mobile device function.

The display control application may further drive a speaker to generate a sound pulse each time the display control application transitions between the first time period and the second time period whereby the user is assisted in maintaining the rhythm at which the application transitions.

Further yet, the sound pulse generated at transition from the first time period to the second time period may be a different sound than the sound pulse generated at transition from the second time period to the first time period.

Further yet, the display control application may break the rhythm when the key switch is activated and: i) if the key switch is activated during the first time period, maintain display of the first icon for a duration of time during which the key switch is activated independent of the alternation time schedule; and ii) if the key switch is activated during the second time period, maintain display of the second icon for a duration of time during which the key switch is activated independent of the alternation time schedule.

Further yet, the display control application may drive the speaker to generate: i) a first audio sound if the key switch is activated during the first time period; and ii) a second audio sound, different from the first audio sound, if the key switch is activated during the second time period.

In an alternative embodiment, the mobile device may further include a second key switch and a second graphic display region associated with the second key switch. In such alternative embodiment, the display control application further drives, on the predetermined alternation time schedule between the first time period and the second time period: i) display of a third icon on the second graphic display region during the first time period when activation of the second key switch activates a third mobile device function; and ii) display a fourth icon, different than the third icon, on the second graphic display region during the second time period when activation of the second key switch activates a fourth mobile device function.

A second aspect of the present invention comprises a mobile device comprising a multi-button switch assembly. Each button of the multi-button switch assembly may be associated with a unique one of a plurality of graphic display regions. A display control application drives, on a predetermined alternation time schedule between a first operational state and a second operational state: i) a one of the plurality of regions associated with a first button of the multi button key switch assembly to display a first icon when the mobile device is in the first operational state; ii) the one of the plurality of regions associated with the first button of the multi button key switch assembly to display a second icon, different than the first icon, when the mobile device is in the second operational state; iii) a second of the plurality of regions associated with a second button of the multi button key switch assembly to display a third icon when the mobile device is in the first operational state; and iv) the second of the plurality of regions associated with the second button of the multi button key switch assembly to display a fourth icon, different than the third icon, when the mobile device is in the second operational state.

The display control application may further drive a speaker to generate a sound pulse each time the display control application transitions between the first operational state and the second operational state whereby the user is assisted in maintaining the rhythm at which the application transitions. Again, the sound pulse generated at transition from the first operational state to the second operational state may be of a different sound than the sound pulse generated at transition from the second operational state to the first operational state.

A third aspect of the present invention comprises a method of operating a mobile device, The method comprises alternating, on a predetermined alternation time schedule: ii) display of a first icon in association with a key switch during a first operational state when activation of the key switch activates a first mobile device function; and ii) display of a second icon in association with the key switch during a second operational state when activation of the key switch activates a second mobile device function.

The first mobile device function is activated in response to detecting user activation of the key switch during the first operational state. And, the second mobile device function is activated in response detecting user activation of the key switch during the second operational state.

The method may further comprise driving a speaker to generate a sound pulse at each transition between the first operational state and the second operational state whereby the user is assisted in maintaining the rhythm at which the transitions. Again, the sound pulse generated at transition from the first operational state to the second operational state may be of a different sound than the sound pulse generated at transition from the second operational state to the first operational state.

In an alternative embodiment, the method may further comprise alternating display, on the predetermined alternation time schedule: i) display of a third icon in association with a second switch during the first operational state when activation of the second key switch activates a third mobile device function; and ii) display of a fourth icon in association with the second key switch during the second operational state when activation of the second key switch activates a fourth mobile device function.

As such, the method of this alternative embodiment also includes: i) activating the third mobile device function in response to detecting user activation of the second key switch during the first operational state; and ii) activating the fourth mobile device function in response to detecting user activation of the second key switch during the second operational state.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a diagram representing a mobile device in accordance with an exemplary embodiment of the present invention;

FIG. 2 is a diagram representing a cross section of a graphic dynamic input device in accordance with an exemplary embodiment of the present invention;

FIG. 3 is a diagram representing an aspect of operation of a control application in accordance with an exemplary embodiment of the present invention; and

FIG. 4 is a table diagram representing an aspect of operation of a control application in accordance with an exemplary embodiment of the present invention.

### DETAILED DESCRIPTION OF EMBODIMENTS

The term “electronic equipment” as referred to herein includes portable radio communication equipment. The term “portable radio communication equipment”, also referred to herein as a “mobile radio terminal” or “mobile device”, includes all equipment such as mobile phones, pagers, communicators, e.g., electronic organizers, personal digital assistants (PDAs), smart phones or the like.

Many of the elements discussed in this specification, whether referred to as a “system” a “module” a “circuit” or similar, may be implemented in hardware circuit(s), a processor executing software code, or a combination of a hardware circuit and a processor executing code. As such, the term circuit as used throughout this specification is intended to encompass a hardware circuit (whether discrete elements or an integrated circuit block), a processor executing code, or a combination of a hardware circuit and a processor executing code, or other combinations of the above known to those skilled in the art.

In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

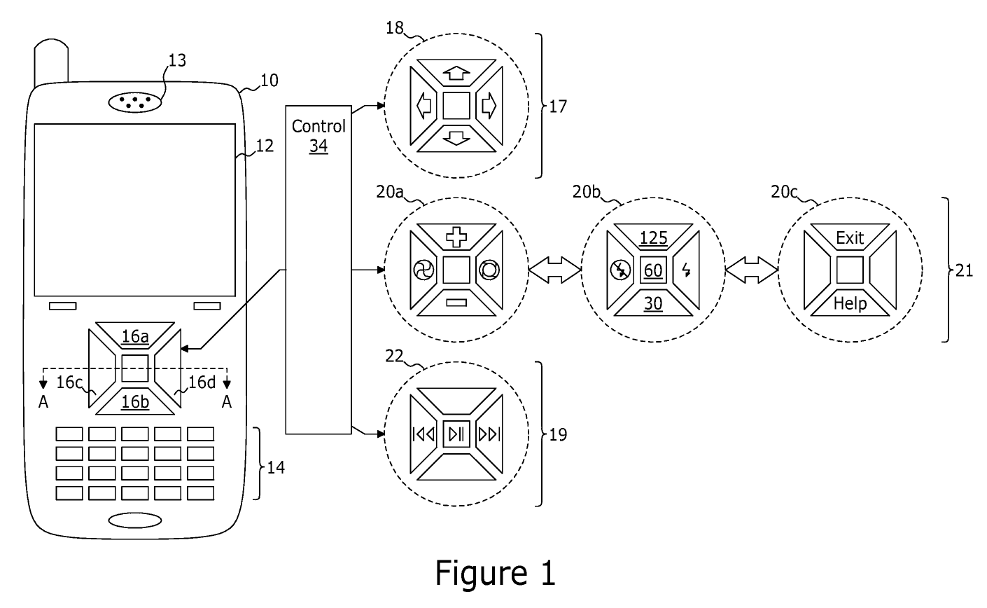

FIG. 1 represents an exemplary mobile device 10 in accordance with the present invention. The mobile device may be implemented as a traditional mobile telephone, PDA, or other similar device. The exemplary mobile device 10 includes a user interface comprising a combination of a display 12 and key switches 14 arranged in a typical telephony format (e.g. 0-9, * and #). In other embodiments, the user interface of the mobile device 10 may further, or alternatively, include a touch panel overlaying the display 12 and/or additional key switches representing a full QWERTY keyboard.

The user interface may further comprise a graphic dynamic input device 16 comprising a plurality of key switches 16a, 16b, 16c, and 16d. Such graphic dynamic input device 16 may be implemented as a five-way navigation input device.

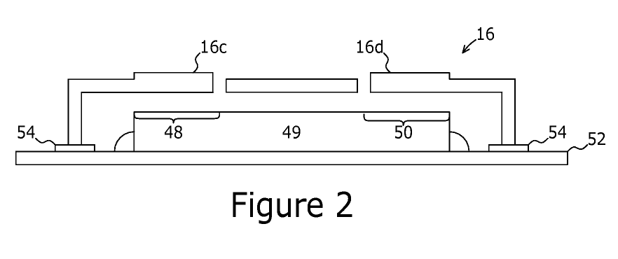

In general, each of the key switches 16a, 16b, 16c, and 16d of the graphic dynamic input device may be associated with a distinct region of a graphic display panel. In an exemplary embodiment, the key switches 16a, 16b, 16c, and 16d of the graphic dynamic input device 16 may be fabricated of a transparent material such as acrylic and overlay the graphic display panel (49 of FIG. 2) such that each key switch 16a, 16b, 16c, and 16d overlays a distinct region of the graphic display panel 49 and such distinct region is visible through the key switch.

For example, with reference to FIG. 2, which represents a cross section view at A-A of the graphic dynamic input device 16, key switch 16c overlays distinct region 48 of the graphic display panel 49 and key switch 16d overlays distinct region 50 of the graphic display panel 49. Further, each key switch 16c, 16d may be coupled to a switch module 54c and 54d respectively. Each switch module 54c, 54d is mounted to a printed circuit board 52 for such that user activation of the corresponding key switches 16c, 16d, may be detected and coupled to other systems implemented on the circuit board 52. Although the cross section view at A-A shows the structure with respect to key switches 16c and 16d, similar structure is utilized for key switches 16a and 16b.

Returning to FIG. 1, a display control application 34 may be coupled to the graphic display panel 49 (FIG. 2) for driving display of a distinct graphic icon (or other indicia) on each of the distinct regions in a manner wherein such graphic icon is visible through its overlaying transparent key switch 16a, 16b, 16c, or 16d. The graphic icon is associated with a function that is activated, invoked, or otherwise called by the display control application 34 in the event that the user activated the overlaying key switch while the graphic icon is visible there through.

In more detail, the display control application 34 may drive one of the distinct regions, for example region 48 (FIG. 2) to display a first icon during a first time period when activation of the key switch 16c overlaying such region 48 activates a first mobile device function and drive the region 48 to display a second icon, different than the first icon, during a second time period when activation of the key switch 16c activates a second mobile device function.

Further yet, each operational state, for example operational state 21 wherein an image capture or camera application is active, the display control application 34 may drive operation in two or three mutually exclusive time limited sub states alternating, on a predetermined time period bases, between driving the display of icon three icon sets.

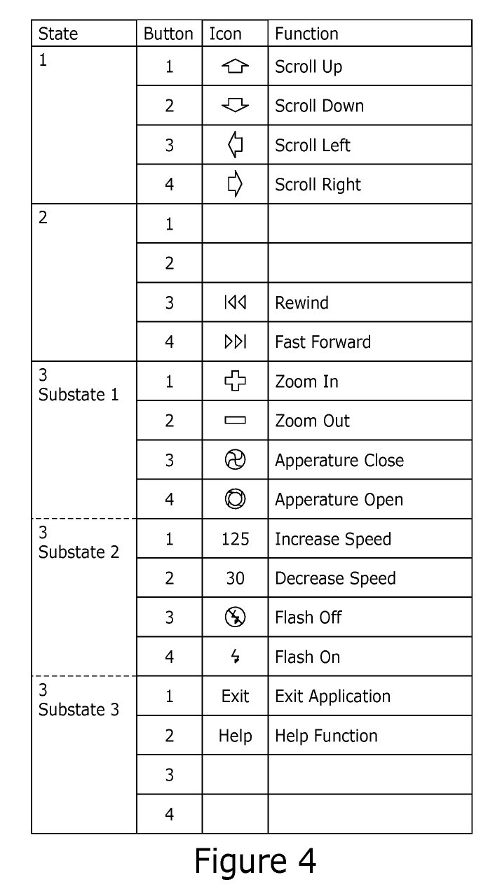

The table of FIG. 4 represents, for each of a plurality of operational states 17, 19, and 21, an exemplary icon which may be displayed through each of the transpired key switches 16a, 16b, 16c, and 16d and the corresponding function which is activated, invoked, or otherwise called by the display control application 34 when such key switch 16a, 16b, 16c, and 16d is activated by the user.

Referring to FIG. 1 in conjunction with FIG. 4, when in the first operational state 17, the display control application 34 may drive the display of icon set 18 (up, down, left, and right arrows). When in the first operational state 17, user activation of each of the key switches 16a, 16b, 16c, and 16d may activate a function of moving a highlight bar (not shown) in the direction of the displayed arrow on the display screen 12.

When in a second operational state 19, such as when an MP3 or other audio and/or motion video application is active, the display control application 34 may drive the display of icon set 22 wherein a “rewind” icon displayed through key switch 16c and a “fast forward” icon is displayed through key switch 16d. When in the second operational state 19, user activation of key switch 16c may activate a rewind function of the MP23 or other audio and/or motion video application. User activation of key switch 16d would activate a fast forward function.

When in a third operational state 21, such as when an image capture or camera application is active, the display control application 34 may drive operation in two or three mutually exclusive time limited sub states alternating between driving the display of icon set 20a, icon set 20b and icon set 20c.

Icon set 20a may, as an example, include a mathematical plus sign icon displayed through key switch 16a, a mathematical minus sign icon displayed through key switch 16b, an icon representing a smaller aperture displayed through key switch 16c, and an icon representing a larger aperture displayed through key switch 16d.

Icon set 20b may, as an example, include a shutter speed number icon displayed through key switch 16a, a shutter speed number icon displayed through key switch 16b, an icon representing “no flash” displayed through key switch 16c, and an icon representing “flash” displayed through key switch 16d.

Icon set 20c may, as an example, include an icon indicating “Exit” displayed through key switch 16a and an icon indicating “Help” displayed through key switch 16b.

When in the time limited sub state wherein icon set 20a is active, user activation of key switch 16a may activate a function to increase photographic zoom (zoom in), user activation of key switch 16b may activate a function to decrease photographic zoom (zoom out), user activation of key switch 16c may activate a function to decrease aperture size, and user activation of key switch 16d may activate a function to increase aperture size.

When in the time limited sub state wherein icon set 20b is active, user activation of key switch 16a may activate a function to increase shutter speed to the speed indicated by the icon, user activation of key switch 16b may activate a function to decrease shutter speed to the speed indicated by the icon, user activation of key switch 16c may activate a function to turn off a flash, and user activation of key switch 16d may activate a function to turn on a flash.

When in the time limited sub state wherein icon set 20c is active, user activation of key switch 16a may activate a function exit the image capture/camera application and user activation of key switch 16b may activate a function to display help topics associated with the image capture/camera application.

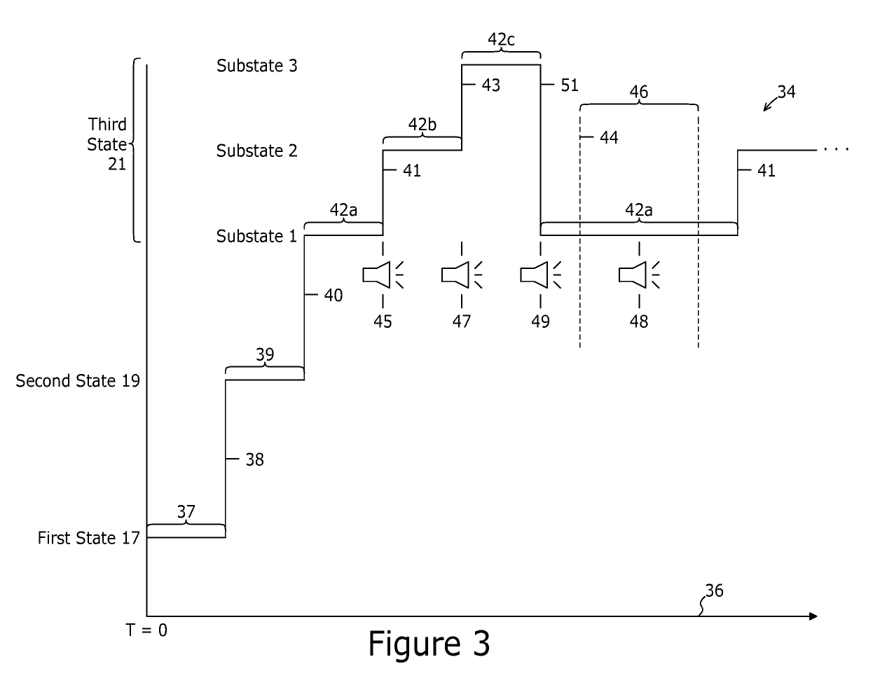

Turning to FIG. 3 in conjunction with FIG. 1, during a course of time 36, the mobile device 10 be in the first operational state 17 for a period of time 37 during which icon set 18 is visible through the key switches 16a, 16b, 16c, and 16d.

Upon user selection to change the active application, or some other state changing event, the control application 33 may transition 38 to the second operational state 19. During a period of time 39 while in the second operational state 19, icon set 22 is visible through key switches 16a, 16b, 16c, and 16d.

Upon user selection to change the active application, or some other state changing event, the control application 34 may transition 40 to the third operational state 21. As discussed, during the third operational state 21, the display control application 34 may drive operation in two or three mutually exclusive time limited sub states alternating between driving the display of icon set 20a (during time periods 42a), icon set 20b (during time periods 42b), and icon set 20c (during time periods 42c). The control application 34 may transition between the sub states utilizing a tempo, or rhythm, on the order of one second. As such, a user may obtain any function in any of the sub states within a two or three second duration of time.

To facilitate a user's ability to activate a key switch 16a, 16b, 16c, 16d at the correct time to achieve a desired function, the control application 34 may drive a speaker 13 (FIG. 1) to generate a sound pulse each time the display control application 34 alternates between the sub states.

In more detail, the sound pulse 45 generated at transition 41 from the first state to the second state may be a different sound pulse than the sound pulse 47 generated at transition 43 from the second sub state to the third sub state, both of which may be a different sound pulse than the sound pulse 49 generated at transition 51 from the third sub state back to the first sub state.

Further, in the event that a key switch is activated during a sub state for a duration of time (for example time duration 46), the display control application 34 may break the transition cycle and maintain display of the icon for the entire duration of time during which the user is activating its overlaying key switch. Also for such duration of time 46, the display control application may drive the speaker 13 (FIG. 1) to generate a sound associated with the function for the duration of time the key switch is activated. For example, with reference to FIG. 1 in conjunction with FIG. 3, if key switch 16a is activated during the sub state when icon set 20a is visible, a sound corresponding to the zoom-in function may be generated for the duration 46. As such, the display control application 34 achieves a function of driving the speaker generate: i) a first audio sound if a particular key switch is activated during the first time period or operational state; and ii) a second audio sound, different from the first audio sound, if the key switch activated during the second time period or second operational state.

Although the invention has been shown and described with respect to certain preferred embodiments, it is obvious that equivalents and modifications will occur to others skilled in the art upon the reading and understanding of the specification. As one example, the diagram of FIG. 2 represents an exemplary embodiment wherein the graphic display is below, and visible through, the key switches. Those skilled in the art will recognize that alternative systems for associating a key switch with a distinct region of a graphic display may be employed. The present invention includes all such equivalents and modifications, and is limited only by the scope of the following claims.

1. A mobile device comprising:
a key switch;
a graphic display region associated with the key switch;
a display control application for:
driving, on a predetermined alternation time schedule between a first time period and a second time period: i) display of a first icon on the graphic display region during the first time period when activation of the key switch activates a first mobile device function; and ii) display a second icon, different than the first icon, on the graphic display region during the second time period when activation of the key switch activates a second mobile device function.

2. The mobile device of claim 1, wherein the display control application further drives a speaker to generate a sound pulse each time the display control application transitions between the first time period and the second time period whereby the user is assisted in maintaining the rhythm at which the application transitions.

3. The mobile device of claim 2, wherein the sound pulse generated at transition from the first time period to the second time period is of a different sound than the sound pulse generated at transition from the second time period to the first time period.

4. The mobile device of claim 1, wherein the display control application further:
i) if the key switch is activated during the first time period, maintains display of the first icon for a duration of time during which the key switch is activated independent of the alternation time schedule; and
ii) if the key switch is activated during the second time period, maintains display of the second icon for a duration of time during which the key switch is activated independent of the alternation time schedule.

5. The mobile device of claim 4, wherein the display control application drives a speaker to generate:
a first audio sound if the key switch is activated during the first time period;
a second audio sound, different from the first audio sound, if the key switch is activated during the second time period.

6. The mobile device of claim 2:
further comprising a second key switch;
a second graphic display region associated with the second key switch; and
the display control application further:
drives, on the predetermined alternation time schedule between the first time period and the second time period: i) display of a third icon on the second graphic display region during the first time period when activation of the second key switch activates a third mobile device function; and ii) display a fourth icon, different than the third icon, on the second graphic display region during the second time period when activation of the second key switch activates a fourth mobile device function.

7. The mobile device of claim 6, wherein the display control application further drives a speaker to generate a sound pulse each time the display control application transitions between the first time period and the second time period whereby the user is assisted in maintaining the rhythm at which the application transitions.

8. The mobile device of claim 7, wherein the sound pulse generated at transition from the first time period to the second time period is of a different sound than the sound pulse generated at transition from the second time period to the first time period.

9. A mobile device comprising:
a multi button switch assembly, each button of the multi button key switch assembly being associated with a unique one of a plurality of graphic display regions;
a display control application for driving, on a predetermined alternation time schedule between a first operational state and a second operational state:
a one of the plurality of regions associated with a first button of the multi button key switch assembly to display a first icon when the mobile device is in the first operational state;
the one of the plurality of regions associated with the first button of the multi button key switch assembly to display a second icon, different than the first icon, when the mobile device is in the second operational state;
a second of the plurality of regions associated with a second button of the multi button key switch assembly to display a third icon when the mobile device is in the first operational state; and
the second of the plurality of regions associated with the second button of the multi button key switch assembly to display a fourth icon, different than the third icon, when the mobile device is in the second operational state.

10. The mobile device of claim 9, wherein the display control application further drives a speaker to generate a sound pulse each time the display control application transitions between the first operational state and the second operational state whereby the user is assisted in maintaining the rhythm at which the application transitions.

11. The mobile device of claim 10, wherein the sound pulse generated at transition from the first operational state to the second operational state is of a different sound than the sound pulse generated at transition from the second operational state to the first operational state.

12. A method of operating a mobile device comprising:
alternating display, on a predetermined alternation time schedule:
display of a first icon in association with a key switch during a first operational state when activation of the key switch activates a first mobile device function; and
display of a second icon in association with the key switch during a second operational state when activation of the key switch activates a second mobile device function; and
activating the first mobile device function in response to detecting user activation of the key switch during the first operational state; and
activating the second mobile device function in response to detecting user activation of the key switch during the second operational state.

13. The method of claim 12, further comprising driving a speaker to generate a sound pulse at each transition between the first operational state and the second operational state whereby the user is assisted in maintaining the rhythm at which the transitions.

14. The method of claim 13, wherein the sound pulse generated at transition from the first operational state to the second operational state is of a different sound than the sound pulse generated at transition from the second operational state to the first operational state.

15. The method of claim 12, further comprising
alternating display, on the predetermined alternation time schedule:
display of a third icon in association with a second switch during the first operational state when activation of the second key switch activates a third mobile device function; and
display of a fourth icon in association with the second key switch during the second operational state when activation of the second key switch activates a fourth mobile device function; and
activating the third mobile device function in response to detecting user activation of the second key switch during the first operational state; and
activating the fourth mobile device function in response to detecting user activation of the second key switch during the second operational state.

16. The method of claim 15, further comprising driving a speaker to generate a sound pulse at each transition between the first operational state and the second operational state whereby the user is assisted in maintaining the rhythm at which the transitions.

17. The method of claim 16, wherein the sound pulse generated at transition from the first operational state to the second operational state is of a different sound than the sound pulse generated at transition from the second operational state to the first operational state.
